(19) United States
(12) Patent Application Publication
(10) Pub. No.: US 2023/0176378 A1
(43) Pub. Date: Jun. 8, 2023

(54) LIGHTGUIDES WITH TUNABLE GRATINGS FOR DYNAMICALLY VARIABLE FIELD-OF-VIEW

(71) Applicant: Facebook Technologies, LLC, Menlo Park, CA (US)

(72) Inventors: Babak Amirsolaimani, Redmond, WA (US); Renate Eva Klementine Landig, Seattle, WA (US); Andrew Maimone, Duvall, WA (US); Giuseppe Calafiore, Redmond, WA (US)

(21) Appl. No.: 17/684,333

(22) Filed: Mar. 1, 2022

Related U.S. Application Data
(60) Provisional application No. 63/286,349, filed on Dec. 6, 2021.
(60) Provisional application No. 63/286,230, filed on Dec. 6, 2021.

(51) Int. Cl. G02B 27/01

(52) U.S. Cl. CPC G02B 27/0172; G02B 6/0035

(57) ABSTRACT

A display apparatus includes a lightguide for conveying images to a user in a target field-of-view (FOV). The lightguide includes a tunable output diffraction grating for displaying different portions of the target field-of-view at different time instances. The tunable output diffraction grating may include grating segments that are selectively switchable between a diffracting state and a non-diffracting state in dependence on a content of an image being displayed, providing content-dependent FOV switching.

### REFERENCE TO RELATED APPLICATIONS

This application claims priority from U.S. Provisional Patent Application No. 63/286,349 entitled “Active Gratings in Pupil-Replicated Displays and Illuminators”, and U.S. Provisional Patent Application No. 63/286,230 entitled “Active Fluidic Optical Element”, both filed on Dec. 6, 2021 and incorporated herein by reference in their entireties.

### TECHNICAL FIELD

The present disclosure relates visual display devices and related components, modules, and methods.

### BACKGROUND

Visual displays provide information to viewer(s) including still images, video, data, etc. Visual displays have applications in diverse fields including entertainment, education, engineering, science, professional training, advertising, to name just a few examples. Some visual displays such as TV sets display images to several users, and some visual display systems such s near-eye displays (NEDs) are intended for individual users.

An artificial reality system generally includes an NED (e.g., a headset or a pair of glasses) configured to present content to a user. The near-eye display may display virtual objects or combine images of real objects with virtual objects, as in virtual reality (VR), augmented reality (AR), or mixed reality (MR) applications. For example, in an AR system, a user may view images of virtual objects (e.g., computer-generated images (CGIs)) superimposed with the surrounding environment by seeing through a “combiner” component. The combiner of a wearable display is typically transparent to external light but includes some light routing optic to direct the display light into the user's field of view.

Because a display of HMD or NED is usually worn on the head of a user, a large, bulky, unbalanced, and/or heavy display device with a heavy battery would be cumbersome and uncomfortable for the user to wear. Consequently, head-mounted display devices can benefit from a compact and efficient configuration, including efficient light sources and illuminators providing illumination of a display panel, high-throughput combiner components, ocular lenses, and other optical elements in the image forming train.

### BRIEF DESCRIPTION OF THE DRAWINGS

Exemplary embodiments will now be described in conjunction with the drawings, which are not to scale, in which like elements are indicated with like reference numerals, and in which:

FIG. 1 is a schematic side cross-sectional view of a display apparatus including a pupil replicating lightguide with an output diffraction grating providing a dynamically adjustable field-of-view (FOV);

FIG. 2 is a schematic top view of a pupil-replicating lightguide, with an eyebox overlapped, including an output diffraction grating with dynamically adjustable parameter(s) in accordance with an image location within a target FOV;

FIG. 3 is a side cross-sectional view of a display apparatus including a pupil replicating lightguide with a de-activated segment of the output diffraction grating outside of a FOV portion containing the image;

FIG. 4A is a schematic plan view of a pupil-replicating lightguide including a segmented output diffraction grating with independently tunable or switchable grating segments;

FIG. 4B is a schematic plan view of the pupil-replicating lightguide of FIG. 4A having a first set of segments deactivated for conveying an image in a top right corner of the FOV;

FIG. 4C is a schematic plan view of the pupil-replicating lightguide of FIG. 4A having a second set of segments deactivated for conveying an image in a bottom left corner of the FOV;

FIG. 5A is a schematic cross-sectional diagram illustrating FOV coupling into a lightguide with the grating pitch of the input and output diffraction gratings tuned for a normal-centered FOV;

FIGS. 5B and 5C are schematic cross-sectional diagram illustrating FOV coupling into the lightguide of FIG. 5A with the grating pitch of the input and output diffraction gratings tuned in dependence of a FOV portion being conveyed to reduce the angular range of in-coupled light;

FIG. 6 is a schematic diagram of a display apparatus for displaying an image frame by time-sequencing through different FOV portions in coordination with an image projector;

FIG. 7 is a schematic view of a FOV superimposed with a plan view of the lightguide;

FIG. 8 is a schematic diagram of an embodiment of the display apparatus of FIG. 6 including a scanning projector;

FIG. 9 is a schematic view of a pupil-replicating lightguide including a tunable output grating, overlapped with a sectioned FOV where different sections of the FOV are displayed at different moments of time;

FIG. 10 is a side cross-sectional view of a lightguide with an electrically controllable diffraction grating at a surface of the lightguide;

FIG. 11 is a schematic diagram illustrating the operation of a switchable LC surface relief grating;

FIG. 12A is a schematic side cross-sectional diagram of a fluidic grating in a non-diffracting (OFF) state in the absence of electrical field;

FIG. 12B is a schematic side cross-sectional diagram of the fluidic grating of FIG. 12A in a diffracting (ON) state in the presence of spatially-modulated electrical field;

FIG. 13 is a flowchart of a method for displaying images using a tunable or switchable diffraction grating to display different FOV portions of a target FOV at different time instances;

FIG. 14 is a view of an augmented reality (AR) display of this disclosure having a form factor of a pair of eyeglasses; and

FIG. 15 is a three-dimensional view of a head-mounted display (HMD) of this disclosure.

### DETAILED DESCRIPTION

While the present teachings are described in conjunction with various embodiments and examples, it is not intended that the present teachings be limited to such embodiments. On the contrary, the present teachings encompass various alternatives and equivalents, as will be appreciated by those of skill in the art. All statements herein reciting principles, aspects, and embodiments of this disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

As used herein, the terms “first”, “second”, and so forth are not intended to imply sequential ordering, but rather are intended to distinguish one element from another, unless explicitly stated. Similarly, sequential ordering of method steps does not imply a sequential order of their execution, unless explicitly stated.

AR and VR displays may use pupil-replicating lightguides to carry images to an eyebox and/or to illuminate display panels that generate images to be displayed. Herein the term “eyebox” means a geometrical area for the user's eye where a good-quality image may be observed by a user of the NED. A pupil-replicating lightguide may include grating structures for in-coupling a light beam into the lightguide, and/or for out-coupling portions of the light beam along the waveguide surface. In accordance with this disclosure, a grating structure of a pupil-replicating lightguide may include a tunable/switchable grating with switchable or tunable diffraction efficiency, grating pitch or grating period, blazing angle, etc. The terms “grating pitch” and “grating period” are used herein interchangeably. The term “tunable” encompasses both continuously tunable and switchable between two or more states. The term “diffraction efficiency” refers to aspects of the performance of the diffraction grating in terms of power throughput of the diffraction grating. In particular, the diffraction efficiency can be a measure of the optical power diffracted into a given direction compared to the power incident onto the diffractive element. In examples described herein, the diffraction efficiency is typically a measure of the optical power diffracted by the grating or a segment thereof in the first order of diffraction relative to the power incident onto the grating or the segment thereof. The term “output efficiency” as used herein refers to a fraction of the optical power of a light source of a display apparatus that is available to the user for viewing images.

An aspect of the present disclosure relates to a display system comprising a lightguide and an image light source coupled to the lightguide. The lightguide is configured to receive image light emitted by the image light source and to convey the image light received in a target field of view (FOV) of the display to an eyebox for presenting to a user. The term “field of view” (FOV), when used in relation to a display system, may refer to an angular range of light propagation supported by the system or visible to the user. A two-dimensional (2D) FOV may be defined by angular ranges in two orthogonal planes. For example, a 2D FOV of a NED device may be defined by two one-dimensional (1D) FOVs, which may be a vertical FOV, for example +\−20° relative to a horizontal plane, and a horizontal FOV, for example +\−30° relative to the vertical plane. With respect to a FOV of a NED, the “vertical” and “horizontal” planes or directions may be defined relative to the head of a standing person wearing the NED. Otherwise the terms “vertical” and “horizontal” may be used in the present disclosure with reference to two orthogonal planes of an optical system or device being described, without implying any particular relationship to the environment in which the optical system or device is used, or any particular orientation thereof to the environment.

Embodiments described herein relate to a pupil replicating lightguide operable to convey to a user different FOV portions at different time instances. Such lightguides include active, i.e. dynamically tunable, diffraction gratings configured to support a variable or switchable FOV and to enable adjusting one or more of the grating's properties to the particular FOV portion being displayed for providing an enhanced viewer experience. In some embodiments, an out-coupling (“output”) diffraction grating of a pupil-replicating lightguide may be segmented, with the segments individually switchable between a diffracting and a non-diffracting state depending on a FOV portion being displayed. By switching to a non-diffracting state a portion of an output grating that doesn't contribute to a FOV portion being currently displayed, grating-related artifacts, e.g. the “rainbow” in AR displays, can be reduced and the image brightness improved. Furthermore, the diffraction efficiency of a currently “FOV-contributing” subs-set of the grating segments may be adjusted to the FOV portion being conveyed, e.g. to provide enhanced image uniformity. In some embodiments, the FOV portion being displayed depends on a content of the image.

In some embodiments, an in-coupling (“input”) grating and an out-coupling (“output”) grating of a lightguide may be operable, i.e. their grating pitch simultaneously tuned, to quickly scan through a sequence of FOV portions of an image. In such embodiments, the image is presented to the viewer in a time-multiplexed manner, with the visual cortex of a viewer integrating the different FOV portions into a single image FOV; this approach may enable a greater overall FOV than can be instantaneously supported by the lightguide. By segmenting the output grating and selectively adjusting the diffraction efficiency of different segments during the FOV scan, the image brightness and/or uniformity of the lightguide may be further improved.

Accordingly, an aspect of the present disclosure provides a display apparatus for displaying images within a target field-of-view (FOV), the display apparatus comprising a lightguide for relaying image light carrying the images to an eyebox. The lightguide comprises a substrate of optically transparent material, the substrate comprising two opposing surfaces for guiding the image light in the substrate by reflections therefrom. The lightguide further comprises an output diffraction grating disposed in or upon the substrate and configured to diffract the image light out of the lightguide toward the eyebox, wherein the output diffraction grating has one or more electrically tunable characteristics and is operable to convey, to the eyebox, different FOV portions of the target FOV at different time instances. The display apparatus further comprises a controller configured to selectively tune the one or more electrically tunable characteristics in dependence on a FOV portion being conveyed.

In some implementations, the one or more electrically tunable characteristics may comprise a diffraction efficiency, and the output diffraction grating may comprise a plurality of grating segments disposed along the surfaces; the controller may be configured to selectively reduce the diffraction efficiency for one or more of the grating segments depending on the FOV portion being conveyed.

In some implementations, the one or more electrically tunable characteristics may comprise an output grating pitch, and the controller may be configured to selectively tune the output grating pitch in at least a segment of the output diffraction grating depending on the portion of the target FOV being displayed. The display apparatus may further comprise an input diffraction grating having an electrically tunable input grating pitch, with the controller configured to tune the electrically tunable input grating pitch in coordination with tuning the output grating pitch. In some of such implementations, the controller is configured to tune the input grating pitch, so as to direct beams of the image light from non-overlapping portions of the target FOV to propagate within the substrate at a same angle of incidence at the surfaces. In these or other implementations, the controller may be configured to tune the input grating pitch so that the image light propagates within the substrate at angles of incidence upon the opposing surfaces thereof smaller than 70 degrees for any FOV portion of the target FOV being conveyed.

Some implementations may comprise a source of the image light and an image processor for controlling the source depending on a content of the image, the image processor being operatively coupled to the controller, wherein the FOV portion being conveyed depends on the content of the image.

In any of the above implementations, the one or more electrically tunable characteristics of the output diffraction grating comprise a grating efficiency, and the controller may be configured to tune the grating efficiency depending on the FOV portion being displayed.

In some implementations, the display apparatus is configured for conveying, to the eyebox, an image in the target FOV sequentially portion by portion, and the controller is configured to at least once tune the one or more electrically tunable characteristics while the image is being displayed. In some of such implementations, the one or more electrically tunable grating characteristics being tuned comprise at least one of an output grating pitch in at least a segment of the output diffraction grating or diffraction efficiency in at least a segment of the output diffraction grating. In some of the above implementations, the output diffraction grating comprises a plurality of individually tunable grating segments, and the controller is configured to selectively tune at least one of the grating pitch or the diffraction efficiency for a subset of the individually tunable grating segments while the image is being displayed, the subset being dependent on the FOV portion being conveyed to the eyebox.

An aspect of the present disclosure provides a display apparatus for displaying an augmented reality (AR) image, the display apparatus comprising: an image projector for providing image light carrying the AR image, a lightguide, and a controller. The lightguide comprises a substrate of optically transparent material, the substrate comprising two opposing surfaces for guiding the image light in the substrate by reflections from the surfaces, and an output diffraction grating configured to diffract the image light out of the substrate for combining with ambient light carrying real scenery and for presenting the AR image to a user within a target field-of-view (FOV), wherein the output diffraction grating comprises a plurality of grating segments, each having an electrically variable diffraction efficiency. The controller is configured to selectively reduce the diffraction efficiency for one or more of the grating segments in dependence on a content of the AR image.

In some implementations of this aspect, the display apparatus is configured to present the AR image in a FOV portion of the target FOV dependent on the content of the AR image, and the controller is configured to switch the one or more grating segments to a substantially non-diffracting state when the one or more grating segments are disposed outside of the FOV portion presenting the AR image. In some implementations, the controller is configured to switch the one or more grating segments from the substantially non-diffracting state to a diffracting state when the content of the AR image changes. In some implementations, the controller may be configured to tune the diffraction efficiency of the one or more grating segments in the diffracting state.

An aspect of the present disclosure provides a method for displaying images to a user within a target field-of-view (FOV), comprising: a) coupling image light into a lightguide having an output region adjacent an eyebox; b) using an output diffraction grating located in the output region of the lightguide to convey to the eyebox different FOV portions of the image light at different time instances, the different FOV portions of the image light being conveyed within different portions of the target FOV; and c) tuning at least one of a grating pitch or a grating efficiency of the output diffraction grating in dependence on a FOV portion being conveyed to the eyebox.

In some implementations, the method may comprise selecting the FOV portion being conveyed depending on a content of the image. In some implementations the method may comprise selecting the FOV portion being conveyed depending on a location of the image content within the target FOV.

In some implementations, the method may comprise using the output diffraction grating to convey, to the eyebox over a frame time interval, the target FOV sequentially portion by portion, at least once during the frame time interval tuning the at least one of the grating pitch or the diffraction efficiency for the FOV portion being displayed.

In some implementations, the method may comprise i) using a scanning image projector to provide image light carrying the image to an input diffraction grating of the lightguide by sequentially scanning a beam of the image light through different portions of the target FOV over a frame time interval, the input diffraction grating tunable to couple the beam into the lightguide; and ii) tuning a pitch of each of the input diffraction grating and the at least a segment of the output diffraction grating in coordination with the scanning.

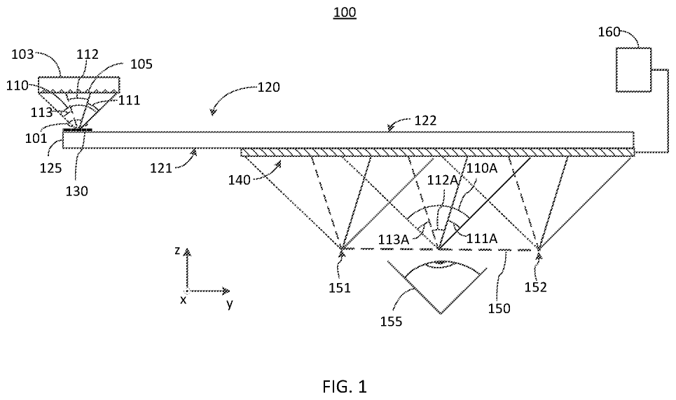

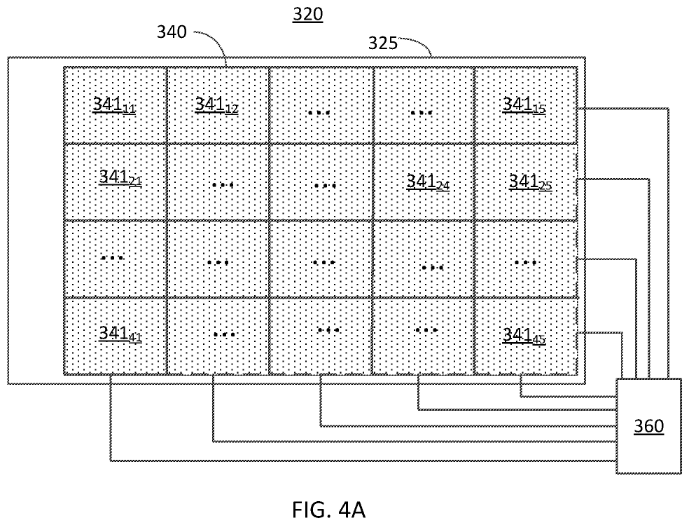

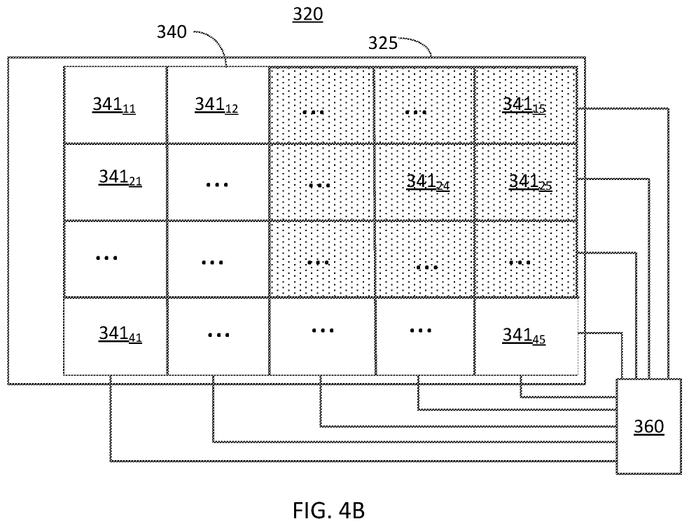

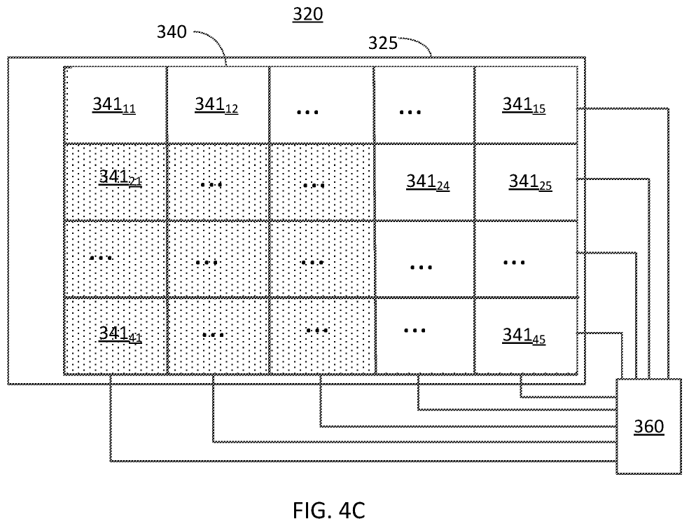

FIG. 1 illustrates an example display apparatus 100 for presenting images to a user, e.g. in the form of image frames. The display apparatus 100 may include an image projector 103 configured to provide image light 101 carrying the images in angular domain within a target field-of-view (FOV) 110 supported by the display. The target FOV 110 may also be referred to herein as the supported FOV or the frame FOV, and may represent a cross-section of a 2D FOV of the display apparatus 100. A lightguide 120 relays the image light 101 to an eyebox 150 of the display apparatus 100. The lightguide 120 includes a substrate 125, which may be e.g. a slab of a material that is transparent to visible light. The substrate 125 has two opposing surfaces 121 and 122, e.g. the main outer surfaces thereof, and is configured for guiding the image light in the substrate in a zig-zag fashion by reflections from the surfaces 121 and 122. An output diffraction grating (ODG) 140 is disposed in or upon the substrate 125 in an output region thereof facing the eyebox 150, and is configured to diffract the image light out of the substrate 125 toward the eyebox 150 for viewing the images within a FOV 110A matching the image FOV 110. The ODG 140 has one or more electrically tunable characteristics or parameters, such as a grating pitch and/or diffraction efficiency, which may be tuned or switched by a controller 160. In some embodiments, the ODG 140 may include a plurality of individually tunable segments tiled side by side along one of the surfaces 121, 122, e.g. as described below with reference to FIG. 4A. The display apparatus 100 may be operated so that different FOV portions of the target FOV 110 or 110A are conveyed to the eyebox 150 at different time instances, with the controller 160 tuning the one or more electrically tunable characteristics of the ODG 140 in dependence on a FOV portion which is currently being conveyed to the eyebox 150. As a non-limiting example, FOV portions 111, 112, 113 of the image FOV 110 may be conveyed to the eyebox 150 at different time instances, for viewing within corresponding FOV portions 111A, 112A, and 113A of the user's FOV 110A, respectively, and the controller 160 may be operated to tune at least one of the grating pitch and the diffraction efficiency in at least a segment of the ODG 140 in dependence on the FOV portion being conveyed.

The image projector 103 may be embodied, for example, using a pixelated display panel, e.g. an LC micro display, optionally having suitable optics at its output. It may also be embodied using a light source, such as e.g. one or more light-emitting diodes (LED), superluminescent light-emitting diodes (SLED), side-emitting laser diodes, vertical-cavity surface-emitting laser diodes (VCSEL), etc., followed by an image beam scanner. The image light 101 provided by the projector 103 within the target FOV 110 is coupled into the substrate 125 by an input optical coupler, such as e.g. an input diffraction grating (IDG) 130 disposed in an input region of the lightguide as illustrated in FIG. 1, or a coupling prism or other suitable coupling means in other embodiments. Is some embodiments, the IDG 130 may also be electrically tunable, e.g. have an electrically tunable pitch, and may be operable to couple different portions of the FOV 110 at different time instances. In some embodiments, both the IDG 130 and the ODG 140 may be segmented, with the segments individually tunable by the controller. In some embodiments, only the ODG 140 may be segmented.

In some embodiments, the image projector 103 may project an image spanning up to the target FOV 110 sequentially portion by portion, each image portion carried by the image light in a corresponding FOV portion, e.g. 111, 112, or 113, with the controller 160 adjusting tuning the grating pitch of the IDG 130 and the ODG 140, or at least a segment thereof, for one or more of the FOV portions. In some embodiments, the controller 160 may tune the ODG 140 in dependence on image content being displayed in a current image frame; in some embodiments this may include e.g. deactivating a segment of the ODG 140, i.e. switching off, or at least substantially reducing the diffraction efficiency, of the segment, in dependence on an image content of the image being displayed. In some embodiments, e.g. when the image content is present only in a portion of the target FOV, the controller 160 may switch off, or at least substantially reduce the diffraction efficiency, of a segment of the ODG 140 that is outside of a FOV portion wherein the image content is present. Here “substantially” refers to a reduction by at least a factor of 5.

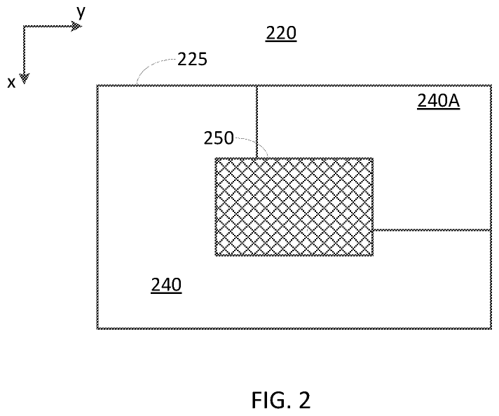

Referring to FIG. 2 for a non-limiting illustrative example, a pupil-replicating lightguide 220, shown in a top view, includes a slab 225 of transparent material for guiding image light in the slab by a series of internal reflections from outer surfaces of the slab 225. The pupil-replicating lightguide 220 includes a switchable grating 240 adjacent to an eyebox 255, both shown in FIG. 2 in a top view in projection on an (x,y) plane parallel to the outer surfaces of the slab. The pupil-replicating lightguide 220, the switchable grating 240, and the eyebox 255 may be embodiments of the lightguide 120, the ODG 140, and the eyebox 155 described above with reference to FIG. 1. An active area, efficiency, and/or pitch of the switchable grating 240 may be adjusted based on the image content being displayed and the position of the image content in the field of view; for example, when displaying an image with the image content confined to a portion of a target image FOV of the display, only a portion 240A of the switchable grating 240 may be configured to diffract image light propagating in the slab 225 toward the eyebox 250. Such an approach may enable higher output efficiency and uniformity when the displayed image content, e.g. colored or b/w text, indicators, auxiliary information, etc., is not covering all of the FOV or does not include one of the R (red), G (green), and B (blue) color channels that is being conveyed by the lightguide. Furthermore, the output diffraction efficiency can be reduced substantially to zero, i.e. turned off (“de-activated”), in a portion of the output grating that is outside of a FOV portion where the image content is present. In displays configured for AR applications, i.e. wherein the region of the lightguide 220 including the output grating 240 is see-through and combines image light carrying AR images with ambient light carrying real life scenery on the other side of the slab, switching at least a portion of the output grating to a substantially non-diffracting state may have an advantage of eliminating see-through artifacts such as the rainbow artifact, and to improve throughput for the ambient light being transmitted through the slab.

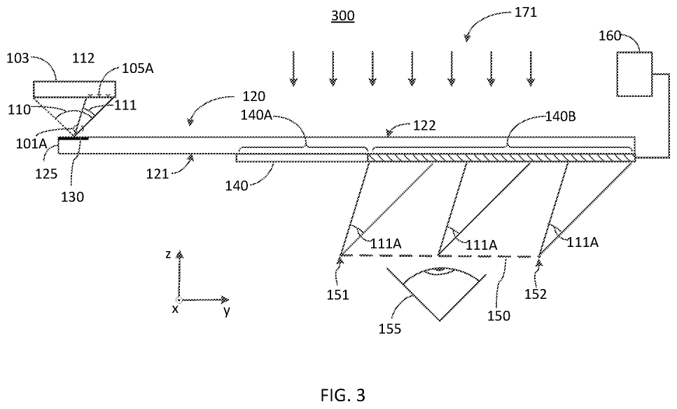

Referring now to FIG. 3, an AR display 300 is an example embodiment of the display apparatus 100 of FIG. 1. In the AR display 300 of FIG. 3, the substrate 125 is substantially transparent to ambient visible light 171, and the ODG 140 is configured to combine the image light carrying AR images with the ambient light 171 carrying real-life scenery, with the combined light illuminating the eyebox 155. The image projector 103 of the AR display apparatus 300 may project an AR image 105A, which content is carried by image light 101A within only the FOV portion 111 of the target FOV 110 supported by the display. From the eyebox 155, the AR image is visible within a corresponding FOV portion 111A, replicated by the ODG 140 to a plurality of locations in the eyebox. A portion 140A of the ODG 140 is outside of the FOV portion 111A carrying the AR image 105A for any location in the eyebox 155. Accordingly, the controller 160 may be configured to de-activate the ODG portion 140A while the image 105A being displayed, i.e. to switch the ODG portion 140A from a diffracting state, in which it may diffract a portion of image light incident thereon from within the substrate 125 toward the eyebox 155, to a substantially non-diffracting state, or to at least reduce the diffraction efficiency thereof. Here, “substantially non-diffracting” means having a diffraction efficiency that is at least 5 time lower than the diffraction efficiency of the same grating portion in the diffracting state. Switching the ODG portion 140A to a non-diffracting state may reduce undesired grating-related artifacts such as image light leakage and the rainbow artifact, which may be caused by undesired diffractions of the image and ambient light, respectively, upon the grating structure of the ODG 140. When the image provided by the image projector 103 changes so that it is carried at least in part by image light within a FOV portion of the target image FOV 110 that is complementary to FOV 111A, the controller 160 may tune the ODG portion 140 back to a substantially diffracting state. The ODG portion 140A may include one or more segments of the ODG 140, which diffraction efficiency at least is individually electrically tunable, including individually switchable between a diffracting and a non-diffracting states in some embodiments. Similarly, the remaining portion 140B of the ODG 140 may also include one or more individually tunable grating segments.

Referring now to FIG. 4A for a non-limiting illustrative example, a pupil-replicating lightguide 320, shown in a top view, includes a slab substrate 325 of transparent material for guiding light therein by a series of internal reflections from outer surfaces of the substrate 325. An electrically tunable/switchable grating 340 disposed in or upon the substrate 325 in an output region thereof includes a plurality of grating segments 341ᵢᵢ, 341₁₂, . . . , 341₄₅, which may be generally referred to as grating segments 341, and which characteristics are individually tunable, e.g. switchable from a diffracting state to a substantially non-diffracting state, by a controller 360. The pupil-replicating lightguide 320, the substrate 325, and the tunable/switchable grating 340 may be embodiments of the lightguide 120, substrate 125, and ODG 140 described above with reference to FIG. 3. Although a 2D array of 20 segments is shown, the number of segments may be different, generally at least two, which may be disposed in a 2D array or along a single direction. By way of example, to display an image in a top right corner of the display FOV, e.g. as illustrated in FIG. 2, the controller 360 may de-activate the grating segments 341 in the first and second columns and the fourth row of the segment array of the tunable/switchable grating 340, as illustrated in FIG. 4B by the non-patterned segments. To display an image in a lower left corner of the FOV, the controller 360 may de-activate the grating segments 341 in the fourth and fifths columns and the first row of the segment array of the tunable/switchable grating 340, as illustrated in FIG. 4C by the non-patterned segments.

Accordingly, in some embodiments a pupil-replicating lightguide includes a slab substrate for guiding light therein and an output grating supported by the substrate, wherein the output grating has a spatially variant tunable efficiency. The output grating may be controlled to out-couple light by a portion of the output grating to form an image only in a portion of a field of view. Such a pupil-replicating lightguide may be used in an AR display.

In some embodiments, a display apparatus such as those described above may have an output diffraction grating having at least a segment with an electrically tunable grating pitch. In some embodiments, the grating pitch of both the input and output diffraction gratings may be synchronously electrically tunable, e.g. in dependence on a FOV portion being displayed, so that rays of the image light are coupled in and out of the substrate at a same angle, thereby preserving the correspondence between the image FOV at the input coupler and the display FOV at seen from the eyebox, while potentially enhancing at least one of the output uniformity of the display or the FOV supported by the display.

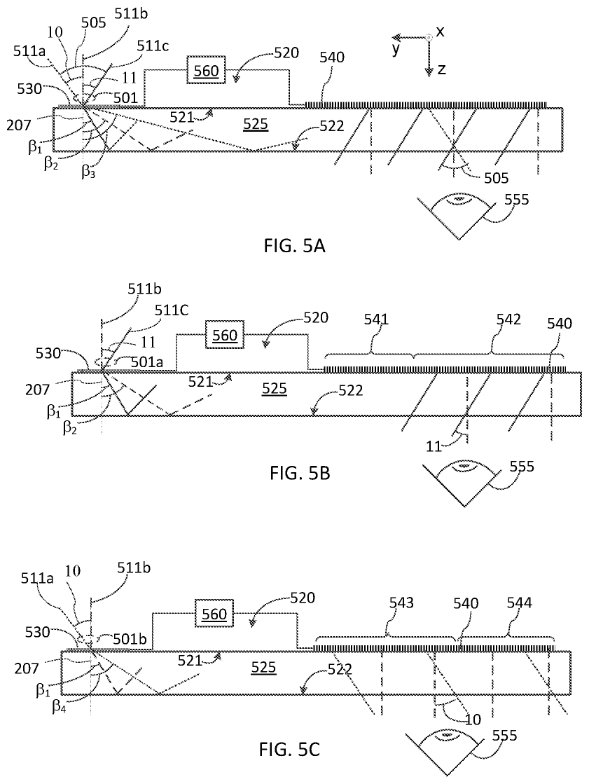

FIGS. 5A-5C schematically illustrate, in a side cross-sectional view, a lightguide 520 including a substrate 525, e.g. a slab of an optically transparent material, having two outer surfaces 521, 522 for guiding image light within the substrate by TIR upon the surfaces. The lightguide 520 further includes an input diffraction grating (IDG) 530 and an output diffraction grating (ODG) 540 disposed in laterally separated input and output regions of the lightguide, respectively, each of IDG 530 and ODG 540 having a grating pitch that is electrically tunable by a controller 560. The IDG 530 may be configured to couple, into the substrate 525, image light 501 incident thereon in a target FOV 505 (FIG. 5A). The target FOV 505 depends on the image light wavelength λ, the grating pitch pᵢₙ of the IDG 530, and the refractive index n of the substrate 525. The target FOV 234 may be e.g. symmetrical to a normal 207 to the substrate 525. In the illustrated example the target FOV 234 includes all rays of the image light that in the angular domain are between ray 511a (dotted line) and ray 511c (solid line), which correspond to propagation angles θ within the substrate 525 between a minimum angle β₁, that may be equal or somewhat exceed the critical angle of TIR β_{c}=a sin(1/n), and some maximum angle β₃=βₘₐₓ≤90°. Here β is the angle of incidence of an in-coupled ray of the image light 501 upon one of the surfaces 521 or 522 from within the substrate. For a given grating pitch pᵢₙ=p₁, the IDG 530 conveys image light within non-overlapping portions of the FOV 505 into non-overlapping angular ranges of the in-coupled light within the substrate. For example, image light within a first FOV portion 10 bound by rays 511a and 511b is coupled into the substrate in angular range between β₁ and β₂. A second FOV portion 11 bound by rays 511b and 511c is coupled into the substrate in angular range between β₂ and β₃. The in-coupled rays of image light at opposing edges of the FOV 505, e.g. adjacent rays 511a and 511c, propagate toward the ODG 540 along different zig-zag paths, with the more oblique ray 511a, which propagates in the substrate 525 at the greatest angle βₘₐₓ, impinging the ODG 540 fewer times and experiencing fewer diffractions out of the substrate than the ray 511c at the opposite edge of the FOV 505. Therefore, it may be difficult to provide a good output uniformity across a wide FOV.

In one embodiment, the lightguide 520 may represent the lightguide 120 of the display apparatus 100 of FIG. 1 or the AR display apparatus 300 of FIG. 3, with the ODG 540 being an embodiment of ODG 140 including a plurality of grating segments, e.g. as illustrated in FIG. 4A, with the segments having individually tunable diffraction efficiency and grating pitch. The controller 560 may selectively tune the diffraction efficiency and/or the grating pitch of different grating segments in dependence on an image content being displayed. In some embodiments, the controller 560 may de-activate, i.e. switch off, one or more first grating segments while tuning the grating pitch of one or more second grating segments.

By way of example, the display apparatus including the lightguide 520 may be configured so that when at a first time instance an image projector thereof, e.g. the image projector 103 shown in FIG. 3, generates image light 501a that is confined to the first FOV portion 11 of the FOV 505, as illustrated in FIG. 5B. Responsive to the image content, the controller 560 operates the IDG 530 so that its grating pitch pᵢₙ=p₁, wherein p₁ is such that the image light 501a propagates within the substrate in the first angular range between β₁≃βc and β₂. Simultaneously, the controller 506 may tune the grating pitch pₒᵤₜ in at least a portion 542 of the ODG 540 so as to out-couple the image rays out of the substrate 525 at the angles of their incidence upon the substrate, a, to convey the first FOV portion 11 to an eye 555 of the viewer substantially without distortion. In some embodiments, the controller 560 may de-activate, i.e. switch off, another portion 541 of the ODG 540 which is outside of the first FOV portion 11 visible to the eye 555.

At a second time instance, the image projector may generate image light 501b confined to the second FOV portion 10 of the FOV 505, as illustrated in FIG. 5C. Were the grating pitch of the IDG 530 stay equal to p₁, the image light 501b would be coupled into the substrate to propagate at more oblique angles to the ODG 140, β₂ and β₃, which may result in a lower output efficiency and/or output uniformity. Instead, in some embodiments, the controller 560 may tune the IDG 530 so that its grating pitch pᵢₙ is reduced, thereby also reducing the maximum angle of propagation within the substrate to β₄<β₃. In some embodiments, the controller 560 may reduce the grating pitch pᵢₙ to a value p₂<p₁ so that the image light 501b is coupled into the substrate 525 in the third angular range (β₁, β₄), which at least partially overlaps with the first angular range (β₁, β₂). Simultaneously, the controller 560 may correspondingly tune the grating pitch pₒᵤₜ in a third portion 543 of the ODG 540, so as to convey the second FOV portion 10 to the eye 555 substantially without distortion. In some embodiments, the controller 560 may be configured to tune the input grating pitch so that the image light propagates within the substrate 525 at angles of incidence β upon the opposing surfaces thereof 521, 522 smaller than 70 degrees for any FOV portion of the target FOV being conveyed. In some embodiments, the controller 560 may de-activate, i.e. switch off, a fourth portion 544 of the ODG 540 which is outside of the second FOV portion 10 being conveyed to the eye 555.

In other embodiments, the lightguide 520 having in-coupling and out-coupling diffraction gratings with a tunable pitch may be operated to display an image sequentially portion by portion, so that different portions of the image corresponding to different partial FOVs are being displayed at different time instances, each time adjusting the grating pitch synchronously in the IDG 530 and the ODG 540, or at least in some portions thereof, depending on the partial FOV being displayed. When the overall target FOV of the image is being scanned over a sufficiently short time, the sequentially displayed FOV portions of the image are integrated by a visual cortex of the viewer into a single image. Using this method, the overall FOV perceived by the viewer may be enhanced.

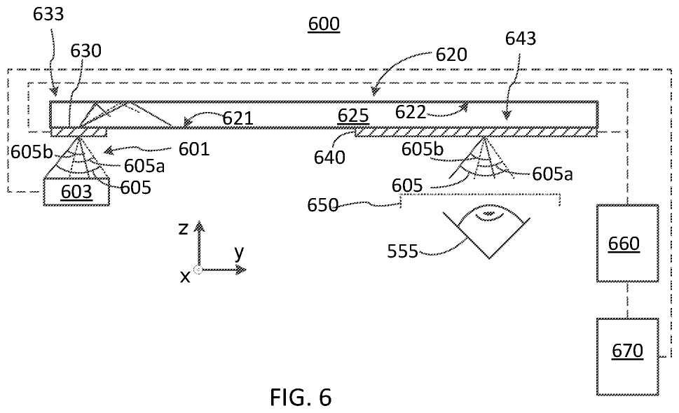

Referring to FIG. 6, a display apparatus 600 is configured to present an image to a user in a time-sequential manner, portion by portion. The display apparatus 600 includes an image projector 603 disposed to provide image light 601 to an input region 633 of a pupil replicating lightguide 620 shown in a side cross-sectional view. The input region 633 includes an IDG 630 having an electrically tunable grating pitch. The lightguide 620, which may be an embodiment of the lightguide 520 described above, includes a substrate 625, e.g. a slab of a material that is transparent to visible light, with two opposing outer surfaces 621 and 622 for guiding the image light in the substrate in a zig-zag fashion by TIR at the surfaces. An ODG 640 is disposed in or upon the substrate 625 in an output region 643 thereof facing an eyebox 650 where the eye 555 of a user is to be located. The output region 643 includes an ODG 640 that has an electrically tunable grating pitch and is configured to out-couple, i.e. diffract, a fraction of in-coupled image light out of the substrate 625 at consecutive incidences, and to direct the out-coupled image light toward the eyebox 650. A controller 660 is electrically connected to each of the IDG 630 and ODG 640 for tuning a grating pitch therein. The lightguide 620 may also incorporate other optical elements, such as e.g. a folding grating, a beam splitter, polarization converter, etc. which are not shown in the figure to avoid clutter.

The image projector 603 may be e.g. an LC display panel or another pixelated display configured to project images in the form of two-dimensional (2D) image frames. Each image frame is carried by the image light 601 in an angular domain, spanning a frame FOV 605, which is indicated in FIG. 6 in a cross-section by the plane of the figure, corresponding to the (y, z) plane of a Cartesian coordinate system (x,y,z) indicated in FIG. 6.

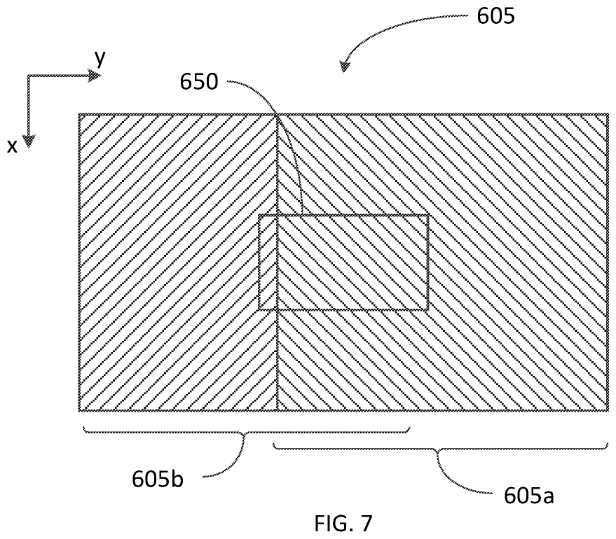

FIG. 7 illustrates a 2D view of the FOV 605, in projection on the plane of the substrate 625, corresponding to the (x,y) plane of a Cartesian coordinate system (x,y,z) indicated in FIG. 6. The y-axis direction may correspond e.g. to a “horizontal” direction of the 2D FOV of the display apparatus. In some embodiments, at least one of the input and output regions 633, 643 of lightguide 620 (FIG. 6) may include a second diffraction grating, to support a 2D FOV of the display. In some embodiments, the second diffraction grating may also be tunable in pitch. In some embodiments, at least one of the IDG 630 and the ODG 640 may have a 2D grating structure.

The image projector 603 may project an image frame upon the IDG 630 in a time multiplexed manner, i.e. portion by portion sequentially in time. Each portion may be projected in a corresponding FOV portion of the frame FOV 605 for a fraction of a frame duration T, e.g. for a time interval Δt=T/N, to be perceived by the user as a single image spanning the frame FOV 605; here N is the number of FOV portions being sequentially transmitted per frame. An image processor 670 provides image information for each FOV portion to the projector 603, e.g. in a digital form, sequentially in time so that the whole frame is displayed over the frame duration T One of the image processor 670 and the image projector 603 may also be operatively connected to the controller 660 to provide information indicative of the FOV portion being displayed, with the controller 660 being configured to adjust the grating pitch of the IDG 630 and the ODG 640 as the FOV portion being displayed changes. Since at each moment in time the lightguide 620 conveys at most a portion of the full frame FOV 605, the frame FOV 605 may include an angular range that is broader than the angular range of light of the same color band that could be coupled into the substrate 632 by a diffraction grating with a fixed grating pitch based on the substrate's refractive index.

In an example embodiment illustrated in FIGS. 6 and 7, for each frame the image projector 603 may project a first FOV portion 605a of the frame FOV 605 during a first half of the frame duration, and may project a second FOV portion 605b of the frame FOV 605 during a second half of the frame duration, with the controller 660 adjusting the grating pitch of the IDG 630 and the ODG 640 accordingly each time the FOV portion changes, to convey the respective first or second FOV portion 605 to the eyebox 650, e.g. as described above with reference to FIG. 5. The FOV portions 605a, 605b propagate in the substrate 625 in a partially overlapping angular ranges, also when the FOV portions 605a, 605b do not angularly overlap outside of the substrate. In some embodiments, the ODG 640 may be non-segmented, with the grating pitch being tuned simultaneously along the full length of the grating in the direction of the y-axis. FIG. 7 illustrates the 2D frame FOV 605 as seen from the eyebox 650. In the illustrated embodiment, the FOV portions 605a and 605b overlap in a center portion of the frame FOV 605; in other embodiments, the FOV portions 605a and 605b do not overlap. In some embodiments, the ODG 640 may be segmented, e.g. as illustrated in FIG. 4a. In some embodiment, each segment of the ODG 640 may be independently tunable in both the grating pitch and the diffraction efficiency. In some embodiments, the diffraction efficiency of a portion of the ODG 640 that is outside of a FOV portion being transmitted, may be de-activated.

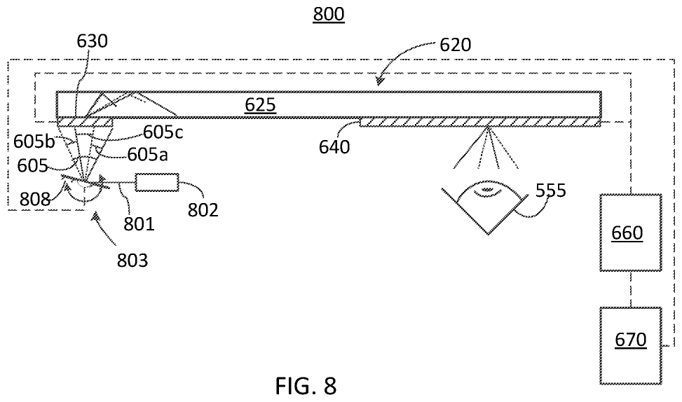

FIG. 8 illustrates a display apparatus 800 which may be an embodiment of the display apparatus 600 in which the image projector 603 is replaced with a scanning projector 803. In FIG. 8, elements having the same or similar functions as corresponding elements shown in FIG. 6 are indicated by same reference numerals and may not be described again. The scanning projector 803 generates each image frame over the frame duration T by angularly scanning a beam 801 of image light in 2D, e.g. using one or more scanning reflectors 808, across the frame FOV 605, responsive to signals from the image processor 670. The beam 801 may be provided by one or more point light sources 802, such as laser diodes (LDs) or light emitting diodes (LEDs) (not shown), which may also be controlled by the image processor 670 in dependence on the image content of the frame being displayed. The controller 660 may be configured to adjust the grating pitch of the IDG 630 and the ODG 640 in synchronization with the scanning projector 803, e.g. synchronously with the tilting of the reflector(s) 808, in dependence on the tilt angle of the reflector(s) 808 and a corresponding angular position of the scanned beam 801 in the frame FOV 605. In some embodiments, the controller 660 may be configured to adjust the grating pitch of the IDG 630 and the ODG 640 two or more times during the frame duration in dependence on a FOV portion currently being scanned. In the example embodiment illustrated in FIG. 8, the controller 660 is configured to synchronously adjust the grating pitch of the IDG 630 and the ODG 640 three times during the frame duration, when the projector 803 scans through three FOV portions 605a, 605b, and 605c, respectively. Similarly to the display apparatus 600, in some embodiments of the display apparatus 800 the ODG 640 may be segmented, e.g. as illustrated in FIG. 4A. In some embodiment, each segment may be independently tunable in both the grating pitch and the diffraction efficiency. In some embodiments, the diffraction efficiency may be de-activated in a portion of the ODG 640 that is outside of a FOV portion being transmitted.

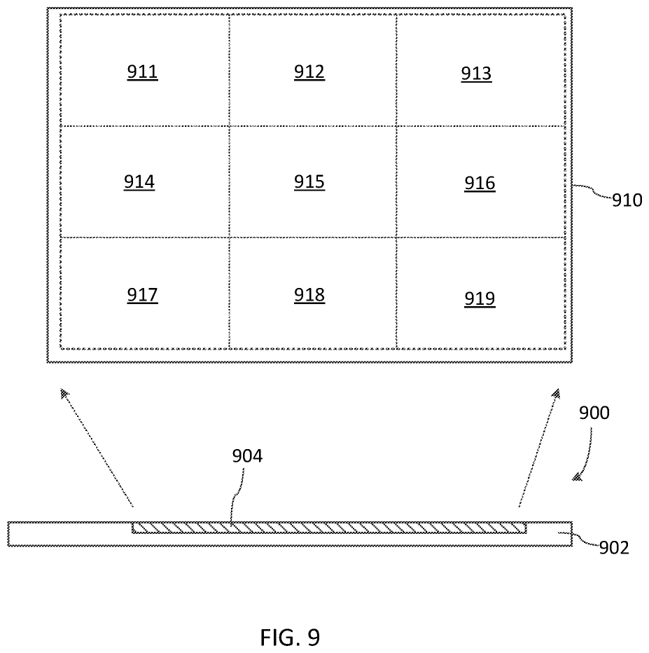

FIG. 9 provides a non-limiting illustrative example of an operation of a pupil-replicating lightguide having a 2D segmented ODG with switchable grating segments for displaying an image frame FOV portion by FOB portion. The pupil replicating lightguide 900 includes a slab substrate 902 of transparent material for guiding light therein by a series of internal reflections from outer surfaces of the slab substrate 902. The pupil-replicating lightguide 900 includes a tunable grating 904, e.g. as illustrated in FIG. 4A, configured to provide, at any given time, only a portion 911, 912, . . . , 919 of an overall frame FOV 910. In some embodiments the tunable grating 904 may be substantially continuous and have an electrically tunable grating pitch. In some embodiments the tunable grating 904 may be segmented, with each grating segment having an independently tunable pitch. In some embodiments the tunable grating 904 may be segmented, with each grating segment having an independently tunable grating efficiency. An image projector including a display panel or a beam scanner, e.g. as described above with reference to FIGS. 6 and 8, may generate the portions 911, 912, . . . , 919 of the frame FOV 910 in a time-sequential manner, and selected segmented of the switchable segmented grating 904 may be switched, and/or the grating pitch in at least a segment of the tunable grating 904 adjusted, in sync with the projector to “place” the portions 911, 912, . . . , 919 at their respective locations in the overall frame FOV 910 one by one. The visual cortex of the viewer will time-integrate the FOV portions 911, 912, . . . , 919 perceiving the frame FOV 910 as a single image.

The approach described above enables providing a large field of view display with a relatively low-index lightguide, which can potentially reduce the weight and/or cost of the display combiner. Furthermore for scanning displays, the output grating(s) may be synced with the instant scanning angle to improve the efficiency of light utilization.

Example embodiments described above include pupil-replicating or illuminating lightguides incorporating one or more grating structures that have variable, i.e. switchable or continuously tunable, grating pitch, also referred to as grating period, and/or variable diffraction efficiency. Some of such grating structures may have other tunable parameters, e.g. the blazing angle that defines the orientation of the grating grooves, or fringes, relative to the input/output surfaces of the lightguide. Some of such switchable or tunable gratings include a material with electrically tunable refractive index, such as but not exclusively a liquid crystal (LC) medium.

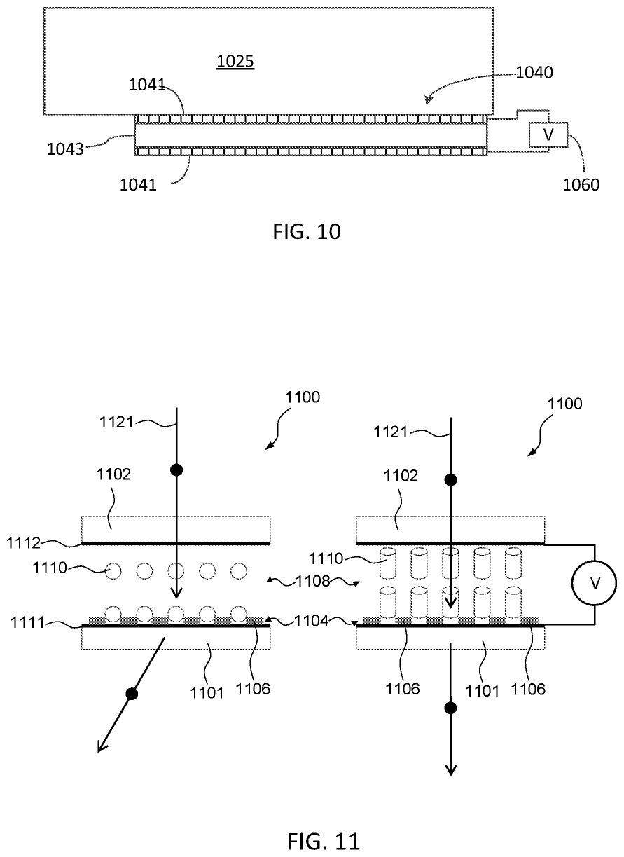

FIG. 10 illustrates an example of an electrically tunable diffraction grating 1040, as may be used in embodiments described above. In the illustrated example, the electrically tunable diffraction grating 1040 is in contact with an outer surface of a substrate 1025. In some embodiments the electrically tunable diffraction grating 1040 may be incorporate within the substrate 1025. The electrically tunable diffraction grating 1040 includes a layer 1043 sandwiched between electrodes 1041 formed with an optically transparent material, e.g. a glass or plastic substrate coated with indium tin oxide (ITO), the layer having an electrically variable periodic refractive index pattern. A controller 1060 is configured to vary at least one of the period, the amplitude, and the blazing angle of the refractive index refractive index pattern, e.g. by varying a voltage applied to the electrodes 1061.

In some embodiments, the material of layer 1043 may contain LC medium, in which case the tunable diffraction grating 1040 may be referred to as an LC grating. The LC medium may include e.g. nematic-type liquid crystals. Nematic liquid crystals may be composed of rod-like molecules that may have non-zero dipole moments and can be approximately aligned by an electrical filed. In another example, the liquid-crystal medium may include cholesteric liquid crystals, in which a molecular stack has a twisted, helical or heliconical structure. The liquid-crystal medium may also include any suitable mixture of nematic liquid crystals, which may have larger, better defined dipole moments and relatively high birefringence, and cholesteric-type liquid crystals, which may have smaller dipole moments but may have the advantage of responding more quickly to changing electric fields. For example, a layer of nematic liquid crystals may be doped with chiral dopants, which may increase the response time of the nematic liquid crystals. The application of an electric field, e.g., by applying a suitable voltage between the electrodes 1041, may orient the dipole moments of LC molecules. For example, the application of an electric field to an LC layer, e.g. layer 1043, may cause the formation of a molecular orientation pattern of the LC molecules, e.g., for nematic liquid crystals, or may modify an existing orientation pattern of the LC molecules, e.g., for cholesteric liquid crystals.

In some embodiments grating 1040 may be an LC grating in which the period of the grating pattern is defined e.g. by pattering a photo-sensitive LC alignment layer, or by a surface relief pattern at an interface between the layer 1043 and a substrate. In the case of tunable surface relief gratings (SRG), LC molecules between the surface relief groves have a different refractive index than the material of the groves. In the absence of the electric field the LC molecules are aligned horizontally, i.e. parallel to the substrate and along the groves, diffracting light polarized along the groves. A voltage applied across the LC layer may align the LC molecules along the electric filed direction, i.e. normally to the layer, thereby substantially eliminating the diffraction.

FIG. 11 illustrates a tunable LC SRG 1100 that may be an embodiment of the tunable grating 1040. The tunable LC SRG 1100 includes a first substrate 1101 supporting a first conductive layer 1111 and a surface-relief grating structure 1104 having a plurality of ridges 1106 extending from the first substrate 1101 and/or the first conductive layer 1111. A second substrate 1102 is spaced apart from the first substrate 1101. The second substrate 1102 supports a second conductive layer 1112. A cell is formed by the first 1111 and second 1112 conductive layers. The cell is filled with a LC fluid, forming an LC layer 1108. The LC layer 1108 includes nematic LC molecules 1110, which may be oriented by an electric field across the LC layer 1108. The electric field may be provided by applying a voltage V to the first 1111 and second 1112 conductive layers.

The surface-relief grating structure 1104 may be polymer-based, e.g. it may be formed from a polymer having an isotropic refractive index nₚ of about 1.5, for example. The LC fluid has an anisotropic refractive index. For light polarization parallel to a director of the LC fluid, i.e. to the direction of orientation of the nematic LC molecules 1110, the LC fluid has an extraordinary refractive index nₑ, which may be higher than an ordinary refractive index nₒ of the LC fluid for light polarization perpendicular to the director. For example, the extraordinary refractive index nₑ may be about 1.7, and the ordinary refractive index nₒ may be about 1.5, i.e. matched to the refractive index nₚ of the surface-relief grating structure 1104.

When the voltage Vis not applied (left side of FIG. 11), the LC molecules 1110 are aligned approximately parallel to the grooves of the surface-relief grating structure 1104. At this configuration, a linearly polarized light beam 1121 with e-vector oriented along the grooves of the surface-relief grating structure 1104 will undergo diffraction, since the surface-relief grating structure 1104 will have a non-zero refractive index contrast. When the voltage V is applied (right side of FIG. 11), the LC molecules 1110 are aligned approximately perpendicular to the grooves of the surface-relief grating structure 1104. At this configuration, a linearly polarized light beam 1121 with e-vector oriented along the grooves of the surface-relief grating structure 1104 will not undergo diffraction because the surface-relief grating structure 1104 will appear to be index-matched and, accordingly, will have a substantially zero refractive index contrast. For the linearly polarized light beam 1121 with e-vector oriented perpendicular to the grooves of the surface-relief grating structure 1104, no diffraction will occur in either case (i.e. when the voltage is applied and when it is not) because at this polarization of the linearly polarized light beam 1121, the surface-relief grating structure 1104 are index-matched. Thus, the tunable LC surface-relief grating 1100 can be switched on and off (for polarized light) by controlling the voltage across the LC layer 1108. Several such gratings with differing pitch/slant angle/refractive index contrast may be used to switch between several grating configurations.

In some embodiments of the LC surface-relief grating 1100, the surface-relief grating structure 1104 may be formed from an anisotropic polymer with substantially the same or similar ordinary nₒ and extraordinary nₑ refractive indices as the LC fluid. When the LC director aligns with the optic axis of the birefringent polymer, the refractive index contrast is close to zero at any polarization of impinging light, and there is no diffraction. When the LC director is misaligned with the optic axis of the birefringent polymer e.g. due to application of an external electric field, the refractive index contrast is non-zero for any or most polarizations of the impinging light, and accordingly there is diffraction and beam deflection.

In some embodiments, the grating 1040 may be a holographic polymer-dispersed liquid crystal (H-PDLC) grating that may be manufactured by causing interference between two coherent laser beams in layer 1143, containing a photosensitive monomer/liquid crystal (LC) mixture, between the two electrodes 1041 having a conductive coating. Upon irradiation, a photoinitiator contained within the mixture initiates a free-radical reaction, causing the monomer to polymerize. As the polymer network grows, the mixture phase separates into polymer-rich and liquid-crystal rich regions. The refractive index modulation between the two phases causes light passing through the layer 1143 to be scattered in the case of traditional PDLC2 or diffracted in the case of H-PDLC. When an electric field is applied across the cell, the index modulation is removed and light passing through the cell is unaffected. A description of such tunable diffraction gratings, which may be switched on and off, is provided in an article entitled “Electrically Switchable Bragg Gratings from Liquid Crystal/Polymer Composites” by Pogue et al., Applied Spectroscopy, v. 54 No. 1, 2000, which is incorporated herein by reference in its entirety.

In some embodiments, the grating 1040 may be a polarization volume hologram (PVH) and/or a Pancharatnam—Berry phase (PBP) liquid crystal (LC) grating. Such gratings may be controlled either directly by applying an electric field to the LC layer, or indirectly by providing a serially coupled half-wave plate (HWP). When the electric field is applied to the LC layer, LC molecules are aligned in the electric field, changing effective refractive index, depending on polarization state of the impinging light.

In some embodiments, layer 1043 of the electrically tunable grating 1040 may include a flexoelectric LC. LC molecules typically are electrical dipoles having a non-zero dipole moment, which usually do not exhibit spontaneous polarization because of equal probability for the dipoles to point to two opposite directions respectively, but become polarized in an external electric field. However LC molecules that do not have a perfect rod-shaped structure, but have e.g. a bend-shaped or a pear-shaped structure, may exhibit spontaneous polarization, termed flexoelectric polarization or flexoelectric effect. In materials with a low dielectric anisotropy and a non-zero flexoelectric coefficient difference (e1-e3), where e1 and e3 are the splay and bent flexoelectric coefficients, respectively, electric fields exceeding certain threshold values may result in a transition from the homogeneous planar state to a spatially periodic one, producing a diffraction grating in layer 1043. The field-induced grating is characterized by rotation of the LC director about the alignment axis in the alignment layer(s) adjacent layer 1043, with the wavevector of the grating oriented perpendicular to the initial alignment direction. The rotation sign is defined by both the electric field vector and the sign of the (e1-e3) difference. The wavenumber characterizing the field-induced periodicity is increased linearly with the applied voltage starting from a threshold value of about it/d, where d is the thickness of the layer. Examples of suitable flexoelectric LC materials, and of LC gratings incorporating such materials that may be used in embodiments of the present disclosure, are described in e.g. in an article entitled “Dynamic and Photonic Properties of Field-Induced Gratings in Flexoelectric LC Layers” by Palto in Crystals 2021, 11, 894, and a U.S. Pat. No. 10,890,823, both of which being incorporated herein by reference in their entireties.

In some embodiments, layer 1043 of the electrically tunable grating 1040 having a variable grating period or a slant angle may include helical and helicoidal LC. Cholesteric LCs (CLC), which have intrinsic periodicity in the form of the helical supramolecular structure, may be obtained e.g. by doping the nematic LC matrix with chiral components. The LC molecules in the mixture may self-organize into a periodic helically twisted configuration including helical structures extending between the top and bottom surfaces of the LC layer 1043. Depending on a type of alignment conditions at the layer surfaces, the helical twist axes of the helical structures may be normal to the surfaces or tilt. The helical structures may form a volume grating that acts as a Bragg grating with the Bragg period equal to one half of the distance P, termed cholesteric pitch, along the helical axis where the LC director and the optic axis rotate by 360°. By varying the applied electrical field, the cholesteric pitch P and thus the Bragg period P/2 of the LC grating may be varied. In some embodiments of LC grating, e.g. some of those including a planar-aligned CLC layer, a diffractive pattern may appear when the applied electric field exceeds a threshold, and may vary in amplitude with the applied field, thereby enabling tuning the diffraction efficiency. In some embodiments a tunable LC grating may include oblique helicoidal LCs, in which the LC director is tilted at an oblique angle to the helical axis. Such LC gratings may have superior tunability because the applied electric field may tune the oblique angles and the pitch lengths in a relatively wide range without disturbing the helical axis orientation. Tunable gratings with oblique helicoidal LCs have been described e.g. in an article entitled “Electrooptic Response of Chiral Nematic Liquid Crystals with Oblique Helicoidal Director” by Xiang et al. Phys. Rev. Lett. 112, 217801, 2014, which is incorporated herein by reference in its entirety.

In at least some embodiments, an LC-based grating 1040 such as those described above may be polarization selective. Such gratings may selectively diffract a light beam having a first polarization, e.g. linear or circular, but transmit a light beam having a second, typically orthogonal, polarization with negligible diffraction. In such embodiments, the display apparatuses described above may operate with polarized image light, e.g. to enhance the display's efficiency, and/or may include various polarizers and polarization converters, such as e.g. quarter-wave plates (QWP), half-wave plates (HWP), a-plates, and lightguides incorporating the same.

Tunable diffraction gratings other than LC grating may also be used in the example embodiments described above. In some embodiments, switchable/tunable gratings may be formed on a surface of the lightguide by providing a surface acoustic wave as disclosed e.g. in an article entitled “Status of Leaky Mode Holography” by Smalley et al., Photonics 2021, 8, 29, 2 which is incorporated herein by reference in its entirety. Such diffraction gratings may be tunable in both the grating pitch, by tuning the frequency of the acoustic wave, and the diffraction efficiency, by tuning its amplitude.

Diffraction gratings with a tunable/switchable diffraction efficiency may also be implemented as fluidic gratings. A fluidic grating may include two immiscible fluid layers, like water and oil, whose interface deforms when a spatially inhomogeneous electric field is applied. The spatially inhomogeneous electric field may be provided e.g. by using spatially inhomogeneous and/or discrete electrodes.

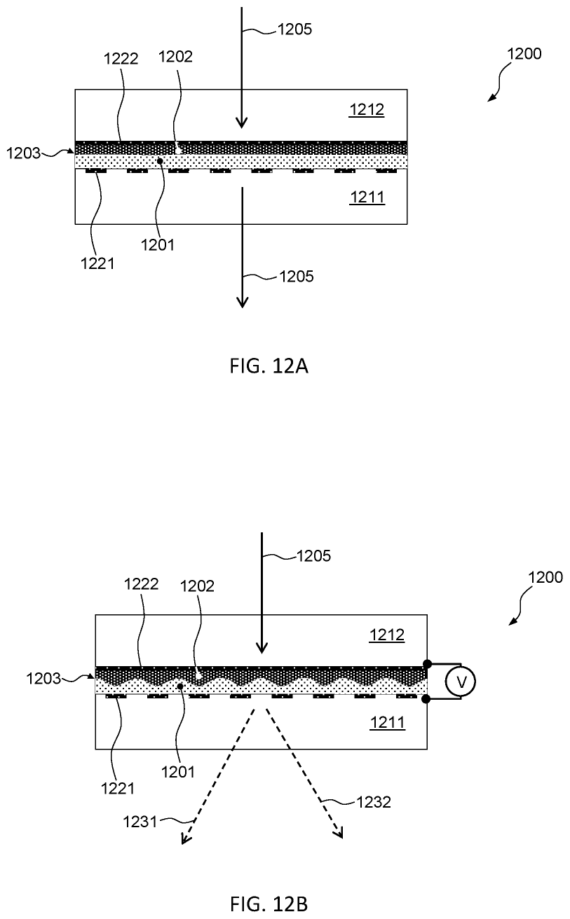

Referring to FIGS. 12A and 12B, a fluidic grating 1200 includes first 1201 and second 1202 immiscible fluids separated by an inter-fluid boundary 1203. One of the fluids may be a hydrophobic fluid such as oil, e.g. silicone oil, while the other fluid may be water-based. One of the first 1201 and second 1202 fluids may be a gas in some embodiments. The first 1201 and second 1202 fluids may be contained in a cell formed by first 1211 and second 1212 substrates supporting first 1221 and second 1222 electrode structures. The first 1221 and/or second 1222 electrode structures may be at least partially transparent, absorptive, and/or reflective.

At least one of the first 1221 and second 1222 electrode structures may be patterned for imposing a spatially variant electric field onto the 1201 and second 1202 fluids. For example, in 12A and 12B, the first electrode 1221 is patterned, and the second electrodes 1222 is not patterned, i.e. the second electrodes 1222 is a backplane electrode. In the embodiment shown, both the first 1221 and second 1222 electrodes are substantially transparent. For example, the first 1221 and second 1222 electrodes may be indium tin oxide (ITO) electrodes.

FIG. 12A shows the fluidic grating 1200 in a non-driven state when no electric field is applied across the inter-fluid boundary 1203. When no electric field is present, the inter-fluid boundary 1203 is straight and smooth; accordingly, a light beam 1205 impinging onto the fluidic grating 1200 does not diffract, propagating right through as illustrated. FIG. 12B shows the fluidic grating 1200 in a driven state when a voltage V is applied between the first 1221 and second 1222 electrodes, producing a spatially variant electric field across the first 1201 and second 1202 fluids separated by the inter-fluid boundary 1203.

The application of the spatially variant electric field causes the inter-fluid boundary 1203 to distort as illustrated in FIG. 12B, forming a periodic variation of effective refractive index, i.e. a surface-relief diffraction grating. The light beam 1205 impinging onto the fluidic grating 1200 will diffract, forming first 1231 and second 1232 diffracted sub-beams. By varying the amplitude of the applied voltage V, the strength of the fluidic grating 1200 may be varied. By applying different patterns of the electric field e.g. with individually addressable sub-electrodes or pixels of the first electrode 1221, the grating period and, accordingly, the diffraction angle, may be varied. More generally, varying the effective voltage between separate sub-electrodes or pixels of the first electrode 1221 may result in a three-dimensional conformal change of the fluidic interface i.e. the inter-fluid boundary 1203 inside the fluidic volume to impart a desired optical response to the fluidic grating 1200. The applied voltage pattern may be pre-biased to compensate or offset gravity effects, i.e. gravity-caused distortions of the inter-fluid boundary 1203.

Portions of a patterned electrode may be individually addressable. In some embodiments, the first electrode 1221 may be a continuous, non-patterned electrode coupled to a patterned dielectric layer for creating a spatially non-uniform electric field across the first 1201 and second 1202 fluids. Also in some embodiments, the backplane electrode is omitted, and the voltage is applied between the segmented electrodes themselves.

The thickness of the first 1221 and second 1222 electrodes may be e.g. between 10 nm and 50 nm. The materials of the first 1221 and second 1222 electrodes besides ITO may be e.g. indium zinc oxide (IZO), zinc oxide (ZO), indium oxide (TO), tin oxide (TO), indium gallium zinc oxide (IGZO), etc. The first 1201 and second 1202 fluids may have a refractive index difference of at least 0.1, and may be as high as 0.2 and higher. One of the first 1201 or second 1202 fluids may include polyphenylether, 1,3-bis(phenylthio)benzene, etc. The first 1211 and/or second 1212 substrates may include e.g. fused silica, quartz, sapphire, etc. The first 1211 and/or second 1212 substrates may be straight or curved, and may include vias and other electrical interconnects. The applied voltage may be varied in amplitude and/or duty cycle when applied at a frequency of between 100 Hz and 100 kHz. The applied voltage can change polarity and/or be bipolar. Individual first 1201 and/r second 1202 fluid layers may have a thickness of between 0.5-5 micrometers, more preferably between 0.5-2 micrometer.

To separate the first 1201 and second 1202 fluids, surfactants containing one hydrophilic end functional group and one hydrophobic end functional group may be used. The examples of a hydrophilic end functional group are hydroxyl, carboxyl, carbonyl, amino, phosphate, sulfhydryl. The hydrophilic functional groups may also be anionic groups such as sulfate, sulfonate, carboxylates, phosphates, for example. Non-limiting examples of a hydrophobic end functional group are aliphatic groups, aromatic groups, fluorinated groups. For example, when polyphenyl thioether and fluorinated fluid may be selected as a fluid pair, a surfactant containing aromatic end group and fluronirated end group may be used. When phenyl silicone oil and water are selected as the fluid pair, a surfactant containing aromatic end group and hydroxyl (or amino, or ionic) end group may be used. These are only non-limiting examples.

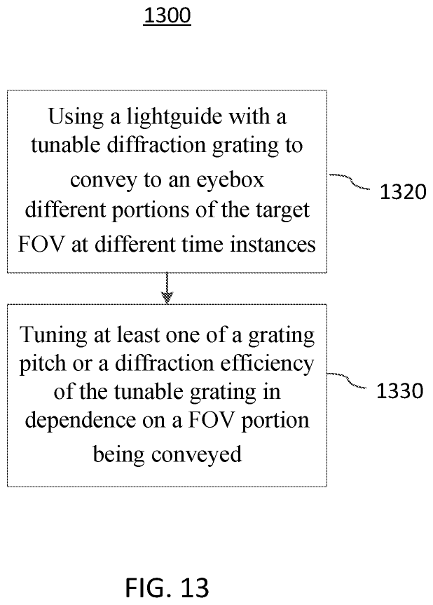

Referring to FIG. 13, example display apparatuses described above may implement a method 1300 for displaying images to a user within a target field-of-view (FOV), which in one embodiment includes the following steps or operations: (1310) using a lightguide with a tunable diffraction grating associated therewith to convey different portions of the target FOV at different time instances to an eyebox of a display apparatus; and, (1320) tuning at least one of a grating pitch or a diffraction efficiency in the output diffraction grating in dependence on a FOV portion being conveyed to the eyebox.

In some embodiments, the method includes coupling, into the lightguide, image light carrying the images in an angular domain, and using an output diffraction grating to couple different FOV portions of the image light out of the lightguide at different time instances. In some embodiments, the method includes selecting the FOV portion being conveyed depending on an image content. In some embodiments, the method includes selecting the FOV portion being conveyed depending on a location of the image content within the target FOV. In some embodiments, the method includes using only a portion of an output area of the output grating to diffract the image light out of the lightguide depending on the FOV portion being conveyed.

In some embodiments, the method includes operating at least a segment of the output diffraction grating to convey, to the eyebox over a frame time interval, the target FOV sequentially portion by portion, at least once during the frame time interval tuning the at least one of the grating pitch or the diffraction efficiency for the FOV portion being displayed.

In some embodiments, the method includes switching the FOV portions being conveyed in synchronization with FOV portions being displayed by an image projector providing the images to the lightguide. In some embodiments, the method includes using a scanning image projector to provide image light carrying the image to an input diffraction grating of the lightguide by sequentially scanning a beam of the image light through different portions of the target FOV over a frame time interval, the input diffraction grating tunable to couple the beam into the lightguide, and tuning a pitch of each of the input diffraction grating and the at least a segment of the output diffraction grating in synchronization with the scanning.

Example embodiments described above have been described by way of example to assist in better understanding of salient features of their operation, and are capable of many variations and modifications. For example in some cases the example embodiments described above may be effective for monochromatic image light. For color images, the image light of different colors may be spatially and/or temporally multiplexed. In some embodiments, two or more stacked lightguides may be used to guide different color channels. In some embodiments, the grating pitch of the input and output couplers of the same lightguide may be tuned to accommodate different color channels in a time multiplexed manner. In at least some embodiments, more than one diffraction grating may be used to couple light out of the lightguide. Some embodiments may utilize more than one input diffraction grating and/or more than one output diffraction gratings, e.g. to support a 2D FOV. When two or more diffraction gratings are used for the in-coupling or the out-coupling, the gratings may be superimposed to form a 2D grating structure, e.g. at a same outer surface of the lightguide's substrate. In other embodiments, different in-coupling gratings or different out-coupling gratings may be disposed at the opposite outer surfaces of the substrate. Embodiments in which one or more input gratings or one or more output gratings are disposed in the bulk of the substrate are also within the scope of the present disclosure. In embodiments where the image light may get diffracted by N≥2 diffraction gratings with grating vectors kᵢ, i=1, . . . , Nin succession, the grating periods of two or more of the diffraction gratings are adjusted so that the grating vectors kᵢ, i=1, . . . , N, sum to zero, i.e. Σ₁^{N}kᵢ=0, for every FOV portion being transmitted.

Embodiments of the present disclosure may include, or be implemented in conjunction with, an artificial reality system. An artificial reality system adjusts sensory information about outside world obtained through the senses such as visual information, audio, touch (somatosensation) information, acceleration, balance, etc., in some manner before presentation to a user. By way of non-limiting examples, artificial reality may include virtual reality (VR), augmented reality (AR), mixed reality (MR), hybrid reality, or some combination and/or derivatives thereof. Artificial reality content may include entirely generated content or generated content combined with captured (e.g., real-world) content. The artificial reality content may include video, audio, somatic or haptic feedback, or some combination thereof. Any of this content may be presented in a single channel or in multiple channels, such as in a stereo video that produces a three-dimensional effect to the viewer. Furthermore, in some embodiments, artificial reality may also be associated with applications, products, accessories, services, or some combination thereof, that are used to, for example, create content in artificial reality and/or are otherwise used in (e.g., perform activities in) artificial reality. The artificial reality system that provides the artificial reality content may be implemented on various platforms, including a wearable display such as an HMD connected to a host computer system, a standalone HMD, a near-eye display having a form factor of eyeglasses, a mobile device or computing system, or any other hardware platform capable of providing artificial reality content to one or more viewers.

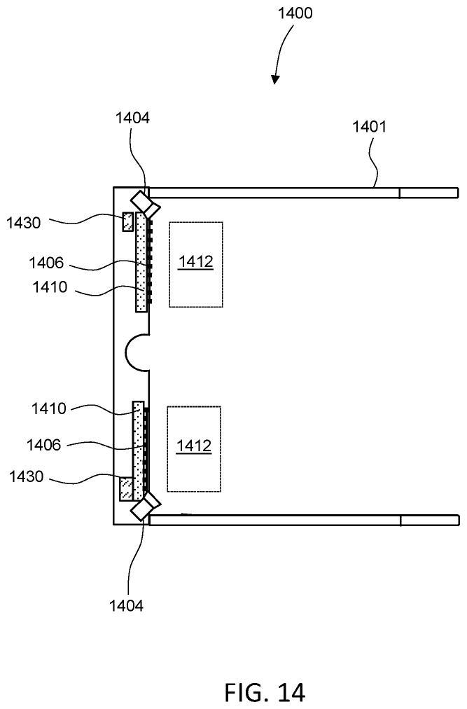

Referring to FIG. 14, a virtual reality (VR) near-eye display 1400 includes a frame 1401 supporting, for each eye: an image projector 1430, e.g. an LC display panel or a scanning projector; a lightguide 1410 including one or more tunable gratings, e.g. as described above, for relaying image light generated by the image projector 1430 to an eyebox 1412 in a dynamically variable FOV. A plurality of eyebox illuminators 1406, shown as black dots, may be placed around the lightguide 1410 on a surface that faces the eyebox 1412. An eye-tracking camera 1404 may be provided for each eyebox 1412.

The purpose of the eye-tracking cameras 1404 is to determine position and/or orientation of both eyes of the user. The eyebox illuminators 1406 illuminate the eyes at the corresponding eyeboxes 1412, allowing the eye-tracking cameras 1404 to obtain the images of the eyes, as well as to provide reference reflections i.e. glints. The glints may function as reference points in the captured eye image, facilitating the eye gazing direction determination by determining position of the eye pupil images relative to the glints images. To avoid distracting the user with the light of the eyebox illuminators 1406, the latter may be made to emit light invisible to the user. For example, infrared light may be used to illuminate the eyeboxes 1412.

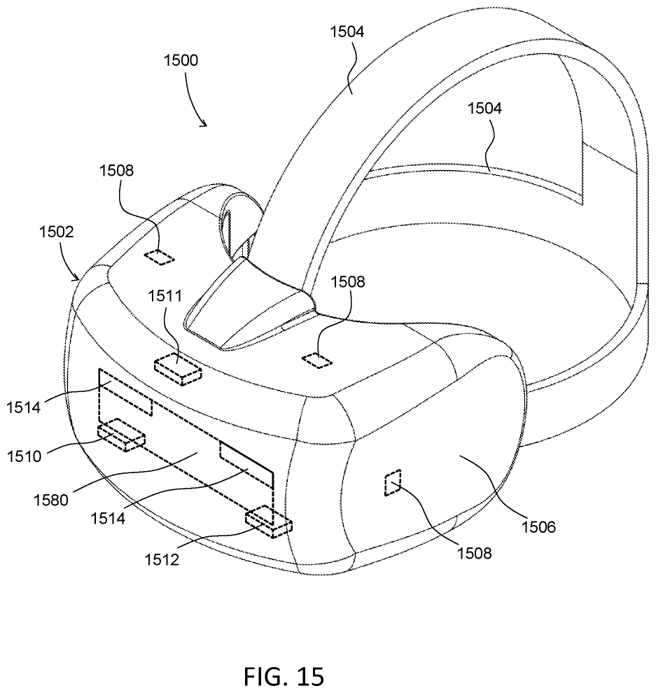

Turning to FIG. 15, an HMD 1500 is an example of an AR/VR wearable display system which encloses the user's face, for a greater degree of immersion into the AR/VR environment. The HMD 1500 may generate the entirely virtual 3D imagery. The HMD 1500 may include a front body 1502 and a band 1504 that can be secured around the user's head. The front body 1502 is configured for placement in front of eyes of a user in a reliable and comfortable manner. A display system 1580 may be disposed in the front body 1502 for presenting AR/VR imagery to the user. The display system 1580 may include any of the display devices, lightguides, and tunable diffraction gratings disclosed herein. Sides 1506 of the front body 1502 may be opaque or transparent.

In some embodiments, the front body 1502 includes locators 1508 and an inertial measurement unit (IMU) 1510 for tracking acceleration of the HMD 1500, and position sensors 1512 for tracking position of the HMD 1500. The IMU 1510 is an electronic device that generates data indicating a position of the HMD 1500 based on measurement signals received from one or more of position sensors 1512, which generate one or more measurement signals in response to motion of the HMD 1500. Examples of position sensors 1512 include: one or more accelerometers, one or more gyroscopes, one or more magnetometers, another suitable type of sensor that detects motion, a type of sensor used for error correction of the IMU 1510, or some combination thereof. The position sensors 1512 may be located external to the IMU 1510, internal to the IMU 1510, or some combination thereof.

The locators 1508 are traced by an external imaging device of a virtual reality system, such that the virtual reality system can track the location and orientation of the entire HMD 1500. Information generated by the IMU 1510 and the position sensors 1512 may be compared with the position and orientation obtained by tracking the locators 1508, for improved tracking accuracy of position and orientation of the HMD 1500. Accurate position and orientation is important for presenting appropriate virtual scenery to the user as the latter moves and turns in 3D space.

The HMD 1500 may further include a depth camera assembly (DCA) 1511, which captures data describing depth information of a local area surrounding some or all of the HMD 1500. The depth information may be compared with the information from the IMU 1510, for better accuracy of determination of position and orientation of the HMD 1500 in 3D space.

The HMD 1500 may further include an eye tracking system 1514 for determining orientation and position of user's eyes in real time. The obtained position and orientation of the eyes also allows the HMD 1500 to determine the gaze direction of the user and to adjust the image generated by the display system 1580 accordingly. The determined gaze direction and vergence angle may be used to adjust the display system 1580 to reduce the vergence-accommodation conflict. The direction and vergence may also be used for displays' exit pupil steering as disclosed herein. Furthermore, the determined vergence and gaze angles may be used for interaction with the user, highlighting objects, bringing objects to the foreground, creating additional objects or pointers, etc. An audio system may also be provided including e.g. a set of small speakers built into the front body 1502.

The present disclosure is not to be limited in scope by the specific embodiments described herein. Indeed, other various embodiments and modifications, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A display apparatus for displaying images within a target field-of-view (FOV), the display apparatus comprising:
a lightguide for relaying image light carrying the images to an eyebox, the lightguide comprising:
a substrate of optically transparent material, the substrate comprising two opposing surfaces for guiding the image light in the substrate by reflections therefrom;
an output diffraction grating disposed in or upon the substrate and configured to diffract the image light out of the lightguide toward the eyebox, wherein the output diffraction grating has one or more electrically tunable characteristics and is operable to convey, to the eyebox, different FOV portions of the target FOV at different time instances; and
a controller configured to selectively tune the one or more electrically tunable characteristics in dependence on a FOV portion being conveyed.

2. The display apparatus of claim 1 wherein the one or more electrically tunable characteristics comprise a diffraction efficiency, wherein the output diffraction grating comprises a plurality of grating segments disposed along the surfaces, and wherein the controller is configured to selectively reduce the diffraction efficiency for one or more of the grating segments depending on the FOV portion being conveyed.

3. The display apparatus of claim 1 wherein the one or more electrically tunable characteristics comprise an output grating pitch, and wherein the controller is configured to selectively tune the output grating pitch in at least a segment of the output diffraction grating depending on the portion of the target FOV being displayed.

4. The display apparatus of claim 2 comprising a source of the image light and an image processor for controlling the source depending on a content of the image, the image processor being operatively coupled to the controller, wherein the FOV portion being conveyed depends on the content of the image.

5. The display apparatus of claim 3 further comprising an input diffraction grating having an electrically tunable input grating pitch, wherein the controller is configured to tune the electrically tunable input grating pitch in coordination with tuning the output grating pitch.

6. The display apparatus of claim 5 wherein the controller is configured to tune the input grating pitch, so as to direct beams of the image light from non-overlapping portions of the target FOV to propagate within the substrate at a same angle of incidence at the surfaces.

7. The display apparatus of claim 5 wherein the controller is configured to tune the input grating pitch so that the image light propagates within the substrate at angles of incidence upon the opposing surfaces thereof smaller than 70 degrees for any FOV portion of the target FOV being conveyed.

8. The display apparatus of claim 6 wherein the one or more electrically tunable characteristics of the output diffraction grating comprise a grating efficiency, and wherein the controller is configured to tune the grating efficiency depending on the FOV portion being displayed.

9. The display apparatus of claim 1 configured for conveying, to the eyebox, an image in the target FOV sequentially portion by portion, wherein the controller is configured to tune the one or more electrically tunable characteristics while the image is being displayed.

10. The display apparatus of claim 9 wherein the one or more electrically tunable grating characteristics being tuned comprises at least one of an output grating pitch in at least a segment of the output diffraction grating or a diffraction efficiency in at least a segment of the output diffraction grating.

11. The display apparatus of claim 10 wherein the output diffraction grating comprises a plurality of individually tunable grating segments, and wherein the controller is configured to selectively tune at least one of the grating pitch or the diffraction efficiency for a subset of the individually tunable grating segments while the image is being displayed, the subset being dependent on the FOV portion being conveyed to the eyebox.

12. A display apparatus for displaying an augmented reality (AR) image, the display apparatus comprising:
an image projector for providing image light carrying the AR image;
a lightguide comprising:
a substrate of optically transparent material, the substrate comprising two opposing surfaces for guiding the image light in the substrate by reflections from the surfaces; and
an output diffraction grating configured to diffract the image light out of the substrate for combining with ambient light carrying real scenery and for presenting the AR image to a user within a target field-of-view (FOV), wherein the output diffraction grating comprises a plurality of grating segments, each having an electrically variable diffraction efficiency; and
a controller configured to selectively reduce the diffraction efficiency for one or more of the grating segments in dependence on a content of the AR image.

13. The display apparatus of claim 12 configured to present the AR image in a FOV portion of the target FOV dependent on the content of the AR image, wherein the controller is configured to switch the one or more grating segments to a substantially non-diffracting state when the one or more grating segments are disposed outside of the FOV portion presenting the AR image.

14. The display apparatus of claim 13 wherein the controller is configured to switch the one or more grating segments from the substantially non-diffracting state to a diffracting state when the content of the AR image changes.

15. The display apparatus of claim 14 wherein the controller is configured to tune the diffraction efficiency of the one or more grating segments in the diffracting state.

16. A method for displaying images to a user within a target field-of-view (FOV), comprising:
coupling image light into a lightguide having an output region adjacent an eyebox;
using an output diffraction grating located in the output region of the lightguide to convey to the eyebox different FOV portions of the image light at different time instances, the different FOV portions of the image light being conveyed within different portions of the target FOV; and
tuning at least one of a grating pitch or a grating efficiency of the output diffraction grating in dependence on a FOV portion being conveyed to the eyebox.

17. The method of claim 16 comprising selecting the FOV portion being conveyed depending on a content of the image.

18. The method of claim 17 comprising selecting the FOV portion being conveyed depending on a location of the image content within the target FOV.

19. The method of claim 16 comprising using the output diffraction grating to convey, to the eyebox over a frame time interval, the target FOV sequentially portion by portion, at least once during the frame time interval tuning the at least one of the grating pitch or the diffraction efficiency for the FOV portion being displayed.

20. The method of claim 16 comprising:
using a scanning image projector to provide image light carrying the image to an input diffraction grating of the lightguide by sequentially scanning a beam of the image light through different portions of the target FOV over a frame time interval, the input diffraction grating tunable to couple the beam into the lightguide; and
tuning a pitch of each of the input diffraction grating and the at least a segment of the output diffraction grating in coordination with the scanning.
